(19) United States
(12) Patent Application Publication
(10) Pub. No.: US 2017/0351824 A1
(43) Pub. Date: Dec. 7, 2017

(54) Advance payment processing system computer for medical service provider bills

(71) Applicant: William J. DeGasperis, Whippany, NJ (US)

(72) Inventor: William J. DeGasperis, Whippany, NJ (US)

(21) Appl. No.: 15/731,544

(22) Filed: Jun. 26, 2017

Related U.S. Application Data
(63) Continuation of application No. 14/121,814, filed on Oct. 20, 2014.
(60) Provisional application No. 62/494,845, filed on Aug. 22, 2016.
(60) Provisional application No. 62/494,851, filed on Aug. 22, 2016.

(51) Int. Cl. G06F 19/00; G06Q 20/38; G06Q 20/32

(52) U.S. Cl. CPC G06F 19/328; G06Q 20/322; G06Q 20/382

(57) ABSTRACT

A system for paying healthcare providers near-instantaneously for services rendered to a specific patient based exclusively on said patient's identity and medical needs. Additionally, the status of said bills, said processing and said payments may be displayed upon a display panel as a result of an automatic signal initiated by said system initiation.

### CROSS-REFERENCES

This is a continuation-in-part application claiming priority to provisional patent applications Nos. 62/494,845 and 62/494,851 filed Aug. 22, 2016 (22 Aug. 2016), and non-provisional patent application Ser. No. 14/121,814 filed Oct. 20, 2014 (20 Oct. 2014).

### BACKGROUND OF THE INVENTION

### Field of the Invention

The present disclosures relates to the field of medical payment processing systems, more particularly, this invention relates to coupling a set of machines remotely located from each other and communicating with each other continuously and simultaneously for providing a medical service provider's bill and payment controlled by data bearing records.

More particularly, the present invention relates to giving healthcare providers real time information regarding which healthcare service will be reimbursed and when, thus assisting healthcare providers with cash flow planning, cost benefit analyses and asset-allocation planning.

### Background

American healthcare, both the public and private delivery systems, is deeply flawed, due to an information barrier which prevents healthcare providers from consistently determining what reimbursable healthcare can be provided to specific patients on a real time basis. This lack of reliable information on medical services service prevents heath care provides from making financially sound decisions as to the rendering of medical services. State and federal officials also need to find the most effective strategies to improve the financing and delivery of healthcare.

Reimbursement is provided by private and public payers. The private payers are primarily health and automobile insurance carriers (where medical benefits are included), and worker's compensation providers. The public payers are primarily governmental entities or programs such as Medicare and Medicaid.

A system is needed to allow healthcare providers real time information regarding which healthcare service will be reimbursed and when. This will provide healthcare providers with information suitable for cash flow planning, cost benefit analysis and asset allocation planning.

The present invention provides healthcare providers with real time regarding which healthcare service(s) will be reimbursed, and when, by identifying the individual patient, identifying said patient's healthcare service requirements, processing said patient's payer's forms for said patient's healthcare service requirements on a prospective basis; and communicating said patient's reimbursable patient's healthcare service options to the user of the present invention.

The present invention also integrates medical billing information systems. More particularly, the disclosed system integrates medical-bill compensation information, and prepares revenue cycle management supporting documentation for billing information systems in order to create supporting documentation for revenue-cycle management. This results in acceleration of the medical billing and collection processes.

One component of the present invention is a computer system a clearinghouse for automated processing of medical and healthcare-related invoices, supporting medical documents, and payment requests using accepted transmission protocols and record formats such as ANSI. A healthcare provider performs a medical service reimbursable by an insurer or other payer and transmits an invoice and supporting medical documentation to the system of the current invention, which is acknowledged, validated and, if complete, reformatted and transmitted to the responsible payer. The payer transmits a claim acknowledgment indicating acceptance or rejection of the invoice and supporting documents to the computer system, which converts the acknowledgment into human readable form and transmits it to the healthcare provider.

Specifically, the present invention is most effective for addressing the specific billing requirement of a defined group, such as the Atlantic Imaging Group (AIG). AIG is a national Preferred Provider Organization (PPO) that specializes in providing diagnostic testing services for patients administered by insurance companies, medical management companies, third party administrators and self-insured entities. These groups are considered the clients of AIG. AIG offers its services to its clients which include Personal Injury/Auto and Worker's Compensation under written agreements called “Payer Access Agreements.”

Payer Access Agreements require AIG to provide the testing, at negotiated prices, either directly or indirectly for the payer or obligor. AIG's agreements with its clients vary in price and responsibilities, which are all the primary obligation of AIG to its client. Under all circumstances, the client is required to pay AIG for medically necessary, covered services.

What about Benefits exhausted or Health Primary? The clients' only interaction with members of AIG's providers is that the client or payer uploads provider Federal Taxpayer Identification information from AIG into its system to identify the provider as a member of the AIG network. The client is not privy to AIG's Agreement with its provider.

AIG also negotiates agreements with testing facilities, and physicians/-medical practices that provide testing at their locations. This group is referred to as “providers” and the agreements are referred to as “Facility Agreements.” In all cases AIG uses a standard agreement that is, by design, onerous to the provider. In approximately nineteen years of operation, very few changes to the standard agreement have been negotiated by the provider. Generally, except as noted below, the terms, representations and warranties are consistent in the contracts. AIG selects which providers it chooses to have in its networks

In addition, in New Jersey and New York AIG operates under legislative provisions establishing the requirements for patients to use networks such as AIG. In New Jersey, AIG is a Voluntary Network established under guidelines established by the Department of Banking and Insurance. AIG is also an Organized Delivery System certified by the Department of Banking and Insurance and both entities are regulated by the department. In New York, AIG is an approved Diagnostic Testing Network and regulated by the New York Workers' Compensation Board and subject to the provisions of that Board, the Department of Health, and Department of Insurance. The regulations dictate compliance-requirements such as the form of ownership, services, geo-access and reporting.

The mainstream of AIG's business consists of a referral by AIG's client into AIG's call center of an approved test that is requested by a third party independent physician who is treating the patient. AIG's call-center personnel contact the patient, understand the patient needs and concerns such as claustrophobia, pregnancy or metal implants, and then determine a network provider that is capable of providing the testing services. The call-center personnel schedule the patient and follow up with the provider with a confirmation of the appointment. AIG's internal system, known as Managed Claims, tracks all appointments to assure that AIG receives the bills for scheduled appointments. This system controls all aspects of our business including scheduling, billing and claim management. Some of the specific modules that the system features are as follows:

The current invention allow entities such as AIG to engage in pre-funding. Using the present invention, AIG can contract with users of the present invention to accelerate the medical-bill payment cycle. In particular, the provider is paid a previously agreed upon rate once a ‘clean’ claim is received and entered into Managed Claims. AIG bills the carrier for reimbursement. If any portion of the claim is unpaid by the carrier, the Provider is subject to full recourse (Reconciliation). Prefunding happens when a user calls eligible claims to a queue within a chosen date range. When the user clicks “prefund selected,” the system generates a check for each claim that is to be prefunded (checked in the queue). The upper portion of the check stub includes pertinent claim information to help the provider identify which claim the check is payment for. This is referred to as a Prefunding Statement. Prefunding is first based on whether or not a Provider Contract includes Prefunding or Standard Funding, alternatively, in its product bundle. Provider Contracts and Contract options are stored in Managed Claims.

Secondarily, prefunding is based on a set of rules; AIG has specific rules that would make a service line and/or a claim prefund eligible or ineligible. These rules are part of the Prefunding Logic. An authorized user may override some of these rules by using the Force Prefunding tool which is done on a claim by claim basis as needed.

The actions of Prefunding, Force Prefunding and Deny Prefunding are all documented within the claim histories of the affected claims for user knowledge and audit history

Reconciliation is an automated way for AIG to recoup money from a provider that was not reimbursed by the payer. There are various reasons as to why this would happen which are outlined in the provider agreement. Rather than issuing the provider an invoice of money owed to AIG, these amounts are calculated and systematically offset against money owed to the provider.

There are three types of Reconciliation: Prefund Reconciliation; Billing Reconciliation; and Admin Fee Reconciliation.

Any time a check is issued from the system, Prefunded or Standard, the system completes a calculation for each Network Provider whereby it totals what is owed to the provider, and subtracts from that any outstanding balances that are owed back to AIG. Thus, the current invention offers accelerated medical invoice cycle completion because existing system execute at the claim level; the present invention allows reconciliation at the provider level.

Thus, for example, at the claim level′ means if $10.00 is owed back on Claim #1 from Provider A, and AIG owes Provider A $20.00 on Claim #2, when the check is issued for Claim #2, the check will be issued for $10.00 and will reference the remaining $10.00 as being offset against Claim #1 specifically. If there were two additional Claims #3 and #4, each worth $20.00 to the Provider, the Provider would get a total of 3 separate checks; one check for $10.00 referencing $10.00 reconciliation, and two checks for $20.00 each.

At the provider level′ means in the same scenario above, a single statement and check would be issued for $50.00 referencing the amounts paid on Claims #2, 3, and 4, and the amount deducted on Claim #1; the $10.00 offset would no longer specifically reduce the reimbursement on Claim #2, rather it would reduce the overall reimbursement of $60.00 to $50.00.

All Reconciliations are all documented within the claim histories of the affected claims for user knowledge and audit history.

In order to ‘trigger’ reconciliation of a balance, the claim related to the balance must be financially closed and an EOB (explanation of benefits) must be issued.

EOB notes trigger various actions within the system; some trigger a claim to appear in various queues to be worked by AIG staff (internal users) or queues that issue letters/bills to Patients relating to the collection of an outstanding balance. Some EOB notes just result in an informational EOB to be issued to the provider indicating a claim has been closed either because it has been paid in full or because the claim has been underpaid for one reason or another and the provider should expect a reconciliation against a future payment as a result of the underpayment. EOB notes and the associated actions are managed within AIG's systems by authorized users.

The actions of financially closing a claim and issuing an EOB set up the outstanding balance for reconciliation against the next payment to the provider. These actions are also documented within the claim histories of the affected claims; a copy of the original EOB is stored as well for user knowledge and audit history.

An EOB note is a comment tied to a service line that is applied when a payment or non-payment is posted to a claim. This note describes the payment or non-payment applied to the individual service line and is printed on the EOB (Explanation of Benefits) that is forwarded to the provider and stored within AIG's system.

Additionally, the present invention integrates medical claims processing for worker's compensation and auto accident claims processing. This clearinghouse computer system is an Internet clearinghouse system designed to process medical claims for personal injuries related to worker's compensation and auto accident matters.

Medical insurance pays the majority the medical treatment bills generated by medical providers, including doctors, health maintenance organizations (HMOs) and medical centers. S aid bills include details required by insurance companies prior to payment of said invoices. Due to the volume, complexity and possibility that said bills are not covered by insurance, the time between the generation of a particular bill and the payment of said particular bill generally takes months. This delay results in additional expenses to said medical providers due to the time value of money.

The deficiencies of the current process for payment of medical bills and the results are known. They include the following:
After hospitals render a service, bills and supporting documents for the service may or may not be submitted for payment;
Hospital collections groups may not follow up effectively on deficiencies from said bills and supporting documents; and
Said lack of follow up results in decreased working capital for hospitals as well as selling accounts receivables to collection agencies, further decreasing the value of the bills rendered.

The current art processes payments using a manual system. In a manual system that doesn't use automated management systems, claims are submitted for payment and are processed accordingly. Traditional means of communication such as phone calls, faxes and mail are used to “notify” submitters that the claim cannot be processed for various reasons. Some of these reasons are outlined below:
Insufficient data or improper data submitted
Incomplete or incompatible dates submitted (for example, date of accident is after date of service)
Lack of supporting documentation which is required for auto and workers' compensation claims
Improper or missing ICD (International Classification of Diseases) or CPT

(Current Procedural Terminology is a medical code set that is used to report medical, surgical, and diagnostic procedures and services to entities such as physicians, health insurance companies and accreditation organizations) codes

While many of these issues are addressed by the use of an electronic claim submission system, the communication back to an individual with the ability to correct the issue is still often done through a manual, non-automated fashion such as a phone call, fax or form letter mailed. Even in cases where the communication is made electronically, proper timely payment relies upon an individual logging into a system and checking the claim status and addressing various issues.

### How is the Process Currently Managed?

In a manual system that doesn't utilize an automated alert management systems, claims are submitted for payment and are processed accordingly. Traditional means of communication such as phone calls, faxes and mail are used to “notify” submitters that the claim cannot be processed for various reasons.

### Shortcomings of Current Process

There is no formal process for communicating back to management or ownership the status of claims in process. Often the only way an owner and/or physician would know that claims are backed up and payments are delayed is if they would physically log into the system and verify that claims are being submitted and paid timely and not held up for various reasons. It is often unrealistic for an individual in this position to be able to pull such information.

Even in the event that this type of access is feasible, it is a “PULL” type request meaning that if the individual doesn't decide to go and get the information, it isn't made readily available. If an owner or physician forgets to check for 2-3 days due to a busy work schedule, status could go from being almost perfect to crisis mode in a very short period of time.

Hence, a need exists to overcome these shortcomings which is met by the current invention. More particularly, the current invention overcomes the shortcomings of the existing systems by ameliorating or eliminating delay.

Prior art includes several issued U.S. patents describing medical billing systems. These include U.S. Pat. No. 5,819,228 (Spiro) issued October 1998; U.S. Pat. No. 5,991,729 (Barry et al.) issued November 1999; U.S. Pat. No. 6,611,846 (Stoodley) issued August 2003; U.S. Pat. No. 6,886,016 (Hansen et al.) issued April 2005; U.S. Pat. No. 7,389,245 (Ashford et al.) issued June 2008; and U.S. Pat. No. 7,739,123 (Rappaport) issued June 2010. As well as US 20160012402 (Neal).

None of these patents teach elimination or minimization of delay. In fact, none disclose a mechanism of payment to the medical service providers issuing invoices or bills for their services to insurers or other liable entities.

Computerized systems also abound for factoring transactions between a funding source and bill-generator to advance funds to the billing entity prior to payment by the liable consumer or third-party such as an insurer. Such a system and method is taught in U.S. Pat. No. 7,617,146 (Keaton et al.) issued Nov. 10, 2009, for example. Such disclosures fail to teach the means to integrate said factoring with electronic clearinghouses, encrypted communications, insurance checklists, government requirements such as HIPAA, or integrated payment systems.

The present invention provides healthcare providers with real time regarding which healthcare service will be reimbursed and when by identifying the patient, identifying said patient's healthcare service requirements, processing said patient's payer's forms for said patient's healthcare service requirements on a prospective basis; and communicating said patient's reimbursable patient's healthcare

Data are “Pushed” as opposed to being “Pulled” to anyone within eyesight of a display device of the client's choosing. The only limitation is that the device must accept a video signal from a High Definition Multimedia Interface (HDMI) output.

Thus, the “Human” factor is removed since the system runs in the background in an unattended mode and the results are displayed in dashboard format on the screen for easy viewing. The dashboard is displayed continuously, 24×7×365.

### Advantages of the Current Invention

The present invention substantially fulfills the foregoing unmet needs. The preferred embodiment of the present invention provides a web-based advanced payment claims processing system that does the following:
Provides a web-based tool that allows receipt of an electronic or hard copy claim and immediately begin processing the claim to ensure that it is a “clean claim.” This processing is done by appropriate personnel who utilize a check-list to ensure that the claim is in fact “clean.” This likely involves obtaining missing medical information and medical reports.
Communicates all status and updates regarding the claim to the provider, medical management company and insurance carrier via the secure web interface.
Ensures prompt payment to the provider, typically within 14 days of receipt of a “clean claim” via pre-funding.
Invoices the carrier based on the approved, clean claim.
Receives payment from the carrier and reconciles the claim (with the difference being an administrative fee for handling the claim).

As commonly understood, the following key terms are defined as:
Provider—a hospital or surgical center that has provided medical services (typically emergency medical services) to an individual who required medical attention due to a personal injury resulting from a Workers' Compensation injury or automobile accident.
Carrier—typically an insurance company that is responsible for paying a claim for medical services rendered for personal injury related services provided at a hospital or surgical center.
HIPAA—the U.S. Health Insurance Portability and Accountability Act of 1996.
HIPAA ASC X 12—HIPAA ASC X12 version 5010 are new sets of standards that regulate the electronic transmission of specific healthcare transactions, including eligibility, claim status, referrals, claims, and remittances. Covered entities, such as health plans, healthcare clearinghouses, and healthcare providers, are required to conform to the new transaction set standards.
Medical Management Company (MMC)—an MMC provides planning, management, cost containment and design services to physicians and other healthcare providers.

With respect to worker's compensation and auto-claims processing, the present invention substantially fulfills the foregoing unmet needs.

The Internet Worker's Compensation and Auto Accident Claims Process Clearinghouse Computer System component of the present invention is an Internet clearinghouse system designed to process medical claims for personal injuries related to worker's compensation and auto accident matters.

The system features the ability to take in many different formats such as ANSI, XML, CSV and even paper claims and process claims for virtually all carriers either electronically or via a print to mail function known as “Banker Box.” The system has the ability to process claims through a web-based, secure user interface or through what we call a “lights out” option whereby claims are processed and results transmitted via secure electronic feeds without any user intervention.

The present invention has both strategic and tactical advantage over existing products. In particular, the present invention is the only electronic direct link to the New York State Insurance Fund (NYSIF). All Worker's Compensation claims based out of New York State must get transmitted to NYSIF. We also transmit electronically to the New York Worker's Compensation Board (NY-WCB). Our electronic transmission is traceable and confirmed and it is required for the carrier to be able to submit an HP1 for late payment.

New York State has special requirements for the submission of ANSI claims for a series of questions that are required and specific to New York State. the computer system of the current invention works with our submitters to populate these questions into the proper sections of the ANSI files so claims are processed properly and paid promptly.

The present invention offers multiple avenues to get data into our system and we provide the necessary outputs to assure prompt payment of the claim. Typically payments are made within 10-14 days of submission of a “clean claim.” Insurance companies often report that the main reason for claim payment delays is due to claims being submitted with missing or invalid information. While the computer system of the current invention does not (and will not) change claim data, we do offer an interface and proper communication and reporting to advise all submitters of information needed in order to be able to process their claim cleanly and get them paid.

The present invention extraction module is an internal sub-section of the system that generates the various outputs necessary to facilitate claim payment and proper reporting. The majority of the work the extraction module does is to create ANSI x-12 output files that are sent to carriers for payment and submitters for status updates. The module also creates certain forms that may be printed manually for signature by the submitter such as the HP1, the Pennsylvania LIBC9 and others. There are also other entities (such as NYSIF and the New York State Worker's Compensation Board) that receive files in non-ANSI standards from us such as XML and CSV.

Unlike health claims, PIP claims require supporting documentation from the medical provider in order to be eligible for payment. This often a pain point for many submitters as the Practice Management systems often don't “talk to” the billing systems. The present invention addresses this issue for our submitters by offering multiple processes to make the submission easy. Supporting documentation can be “attached” and sent in with a pre-printed bar coded that links the documentation to the claim. The present invention also offer a unique process called “InstaDoc” whereby submitters can “drag and drop” through a graphical interface to attach supporting documents to claims. Finally, for the technically savvy submitters, the present invention offers specific segments of the ANSI x-12 837 form to specify the file name of the associated attachment in the claim transmission. The present invention document all of these options in a “Companion Guide” which can be made available to all submitters during the implementation phase.

Through the present invention's On-Line User Interface users can see “dashboard” views showing the status of their claims and ensure that the claim is “clean” before it is transmitted for payment. The present invention also sends emails and other reminders alerting users about claims that need their attention. The assurance of a “clean” claim for processing has been proven to significantly improve the number of days it takes to get paid.

The present invention offers submitters a “one stop shop” in that the present invention can accept claims for any carrier regardless of whether or not we (or one of our trading partners) have an electronic relationship with the carrier. In the case that there is no electronic relationship, the present invention has the ability to print to mail the claim and provide detailed tracking information about the claim through our user interface.

### Typical Benefits

The typical benefits of the current invention includes a benefit to providers in that their claims paid within 14 days of acceptance which improves their cash flow tremendously. The percentage of the discount that they are giving up to receive the payment promptly makes business sense for the provider. The benefit to the processing service-provider is the spread on the prefunded amount and amount billed to the provider. The benefit to the MMC is a streamlined process for ensuring the claim is clean and approved at the proper rate.

### Technical Features

The preferred embodiment of the present invention integrates certain technologies, unlike existing offerings, as follows:
The web site is HIPAA compliant and uses appropriate technologies for encryption, authentication and displaying medical information that has PII and PHI on the screens.
The web site must either support or interface with an electronic clearing house that allows for the proper receipt and transmission of HIPAA ANSI X12 compliant electronic billing files. The 5010 version of the 837i and the UB04 form must be accepted electronically and in paper form and the proper receipt and acknowledgement files such as the 999 and 277/277 CA files must also be transmitted to the submitter as per HIPAA ANSI X12 guidelines.
Invoices, payments and status updates must be transmitted appropriately and securely and may include third-party software and/or partners to accomplish such activities.

Inputs for the present invention include the following.
Provider bills are accepted electronically into iHCFA (ANSI HIPAA File Format 837i for Institutional Billing, v. 5010, UB04 for Hospital Billing).
Keyed billing data is entered into web site via secure form.
Hard copy of 5010 or UB04, may be keyed into web site and/or scanned.
Payments are received from carriers to reconcile claims, difference between payment received and pre-fund disbursement is the fee for processing the claim within 14 days.

The process of the preferred embodiment of the present invention includes the following.
Prepare and track a required checklist of documentation associated with the provider bill until the claim is “clean” and complete.
Submit the checklist, bill and supporting documents to the MMC and obtain acceptance.
Upon acceptance, electronically submit the bill and attachments to the payer in their desired electronic format.
Communicate with the provider when a bill is considered “complete” and under review (14 day or other time clock starts here).
Provide a clock for users responsible for receiving the approval from the carrier.
Calculate a previously agreed upon percentage of the approved bill amount.
Integrate with financial systems to request funding and ultimately fund the provider within 14 days.
Update the user interface (web site) with appropriate status and information.
Receive the incoming payment from the carrier and reconcile the claim.

The outputs of the preferred embodiment of the present invention include the following.
Provide a complete checklist with dates and approvals to the MMC and/or facility indicating the status of the claim, 14 days period starts once the checklist is complete.
Provide status updates to the facility, MMC and carrier via the user interface (web site).
Payment within 14 days of approval to the provider.
Provide a bill to the carrier for the services rendered.
Provide various reports to web site users such as Claims in Processing, Tickler Reports and Prefunding Status Report.

### SUMMARY OF THE INVENTION

A system for paying healthcare providers near-instantaneously for services rendered to a specific patient based exclusively on said patient's identity and medical needs. Additionally, the status of said bills, said processing and said payments may be displayed upon a display panel as a result of an automatic signal initiated by said system initiation.

The present invention allows for the near-instantaneous prospective payment to a medical provider for proposed services associated with a particular patient's medical needs. The present invention also allows near-instantaneous payment to a medical provider for services rendered to said patient for said medical need. The present invention may also be applied to public and private payers.

A system for inputting medical bills related to a specific patient for a specific medical need, processing said bills, and paying said bills nearly instantaneously. Said system is initiated by the identity of said patient and said patient's medical requirements. Additionally, the status of said bills, said processing and said payments may be displayed upon a display panel as a result of an automatic signal initiated by said system initiation.

The system is comprised of at least one computer capable of creating an intermediate data base containing information items related to said bills, insurance/carrier data requirements, and data related to said requirements.

The system is also capable of sending payments of said bills to providers as directed by said computer.

An important aspect of the invention is the system's capability to comply efficiently with the restrictions of the HIPAA and other criteria and specifications mandated by governmental authorities such as the federal Office of Management and Budget (OMB) and standards-setting organizations such as the American National Standards Institute (ANSI), E-Health Standards and Services (OESS), and the National Uniform Billing Committee (NUBC) of the American Hospital Association, in addition to proprietary and nonstandard data formats.

### System Description

The system comprises of three major components which are as follows:

1. Web Service—The web service simply “delivers” the dashboard information in a safe, secure, encrypted manner using the internet. The data is pushed out from our hosted website and database through a web service to the monitoring Receiving device.

2. Receiving Device—The receiving device is a small device that utilizes a secure wireless connection to the internet and the device is programmed for the specific submitter. The software that resides on the device. The input to the device will be receiving the data sent from the Web Service. The processing on the device will be to format the data in a human readable dashboard format and output will be sending the dashboard to the display panel through the HDMI interface.

3. Display Panel—The display panel is simply a display device that accepts an HDMI input and will display the dashboard information received from the receiving device.

The present invention will be providing to the submitter the Web Service configuration and the Receiving Device. The submitter will pay a monthly fee for the service and the rental of the device. Due to the many options on the display panel (Flat Screen TV, monitor, Reader Panel, etc.) and the environmental factors, the present invention does not provide the display panel or the cabling that runs from the receiving device to the display panel.

The system is written in Microsoft Visual Studio® 2010 using ASP.NET and C#.NET as the code base. The back-end database is Microsoft SQL Server® 2012.

### BRIEF DESCRIPTION OF THE DRAWINGS

FIG. 1 illustrates a block diagram of an exemplary process flow in accordance with the principles of the invention (previously presented as FIG. 1 of 1 in Ser. No. 14/121,814).

FIG. 2 illustrates the relationship among the subsystems required for operation of the user-facing component, as it relates to the data-system component of the present invention.

FIG. 3 is a flowchart schematic of the key inputs and transformations of the worker's compensation element of the present invention (previously presented as FIG. 1 of 1 in Ser. No. 62/494,845).

FIG. 4 is a flowchart detailing the key elements and processes of the current invention (previously presented as FIG. 1 of 3 in Ser. No. 62/494,851).

FIG. 5 is a flowchart depicting the protocols necessary to enable the current invention (previously presented as FIG. 2 of 3 in Ser. No. 62/494,851).

FIG. 6 is a flowchart depicting the validation and error-summary processes (previously presented as FIG. 3 of 3 in Ser. No. 62/494,851).

The invention will be better understood and objects other than those set forth above will become apparent when consideration is given to the following detailed description thereof. Such description makes reference to the annexed drawing.

### DETAILED DESCRIPTION OF THE INVENTION

There are two major components of the current invention: the data system and the user-facing system.

Said user-facing system may be initiated by facial recognition or other bio-identity systems, or input key by a patient or other user in conjunction with input associated with said patient's healthcare requirements. Said requirements can be introduced to the present invention via an automated diagnostic system such as a video-feed or by keyed input.

The present invention is used in conjunction with a funds-holder such as a bank. The present invention will communicate an authorization to transfer funds from MedicaFund to said healthcare provider after said healthcare-provider/bill-generator confirms having rendered required services to said patient.

Said funds transfer amount is less than or equal to the reimbursement amount agreed to be paid by a payer (such as an insurer) to MedicaFund at some later date.

Said data system is composed of three separate computer systems which are remotely located from each other. Each of said computer systems accesses a data base which is uniquely associated with it.

Said data system is capable of sending and receiving data from said user facing data system; associating data related to said patients and said users which are proximate to said common medical service provider; and automatically sending said associated data concerning said patients to said users.

Said data system is composed of three computer systems. More particularly, a first computer system is associated with a healthcare service provider data base.

Said first computer data base has information related to patient and patient services rendered.

Said patient information such as any information that can be used to identify, contact, or locate an individual, either alone or combined with other easily accessible sources. It includes information that is linked or linkable to an individual, such as medical, educational, financial and employment information. Examples of data elements that can identify an individual include name, fingerprints or other biometric (including genetic) data, email address, telephone number or social security number. Said patient information is time stamped which allows said patient's proximity to said healthcare provider's facility to be determined.

Said patient services rendered information such as care, services, or supplies related to the health of an individual. It includes, but is not limited to, the following: (1) Preventive, diagnostic, therapeutic, rehabilitative, maintenance, or palliative care, and counseling, service, assessment, or procedure with respect to the psychical or mental condition, or functional status, of an individual or that affects the structure or function of the body; and (2) Sale or dispensing of a drug, device, equipment, or other item in accordance with a prescription.

Second computer system is associated with a healthcare payer data base.

Said second computer data base has information related to covered transactions and claims.

Said covered transactions are healthcare services which result in a contractual obligation to pay another for services rendered. Said covered transaction are payable if they meets regulatory and statutory requirements.

Said claims are healthcare claims or equivalent encounter information transaction is either of the following: (a) A request to obtain payment, and necessary accompanying information, from a healthcare provider to a health plan, for healthcare or (b) If there is no direct claim, because the reimbursement contract is based on a mechanism other than charges or reimbursement rates for specific services, the transaction is the transmission of encounter information for the purpose of reporting healthcare.

Third computer system is associated with a payment data base.

Said third computer data base has information related to eligibility and payments.

Said eligibility is information related to a person's qualification for the payment of said claim based on either of the following: (a) An inquiry from a healthcare provider to a health plan, or from one health plan to another health plan, to obtain any of the following information about a benefit plan for an enrollee: (1) Eligibility to receive healthcare under the health plan; (2) Coverage of healthcare under the health plan; (3) Benefits associated with the benefit plan or (b) A response from a health plan to a healthcare provider's (or another health plan's) inquiry described in paragraph (a) of this section.

Said payments are transmission of any of the following said healthcare provider's financial institution: (1) Payment; (2) Information about the transfer of funds; (3) Payment processing information including remittance advice.

Said three computer systems are in constant and simultaneous communication with each other.

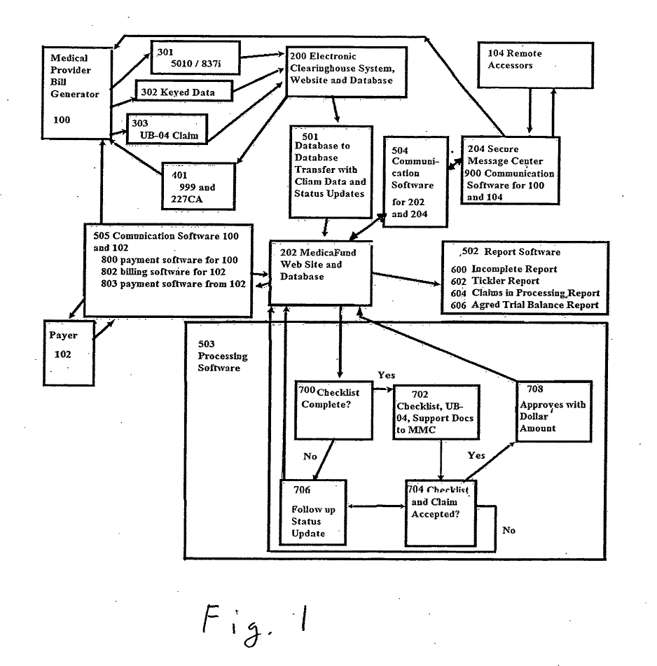

More specifically, referring now to FIG. 1 regarding the data system, the following describes same.

One embodiment of the current invention operates under the name “MedicaFund”, which controls a website and database suitable for advance payment of provider-invoices for covered services, whereby a healthcare provider submits bills to the system for validation and pre-funding instead of to the insurer or other payer. When the current invention is used, the following transaction sequence typically occurs. A hospital performs a service. The hospital forwards bills and supporting documents to MedicaFund. MedicaFund utilizes an iHCFA clearinghouse to audit bills for completeness. iHCFA communicates any missing bill data back to assigned hospital personnel for completion. MedicaFund reviews supporting documents and checklist requirements. MedicaFund works with hospital personnel until all applicable checklist requirements have been satisfied. MedicaFund transmits bills, supporting documents, and checklist to MMC. MMC audits bills, supporting documents and checklist, then notifies MedicaFund if bill is “clean”.

MedicaFund notifies the hospital when the bill is “clean” and begins the 14-day payment clock. The MMC performs a bill review and eligibility assessment within 10 days or less. The MMC notifies MedicaFund when the bill is approved for payment. MedicaFund then pays the bill. Said transaction set can be completely automated when MMC is an MMC application and MedicaFund is also implement in software. Said MMC and MedicaFund applications can be run on a single computer or may be distributed among other processors. Payments and communications may be electronic or paper-based. Thus the computer-based system may integrate both paper and electronic communications, generating electronic mail in addition to traditional postal mail, as well as electronic payments and paper checks.

Paper-based implementations render the desirable short payment time frames and time value of funds unworkable. Therefore in the preferred embodiment, all communications and payments are electronic.

Referring now to the system overview of FIG. 1, it is shown that the system interacts with three principal user groups: a medical provider bill-generator 100, the payer 102 of the bills generated by provider 100, and optional remote accessors 104. Payer 102 is typically an insurance carrier, self-insured company, or other entity liable by contract or otherwise.

The system has two principal hardware components: an electronic clearinghouse system website and database 200, and a MedicaFund website and database 202. Electronic clearinghouse component 200 and MedicaFund component 202 may be configured into a single computer or installed in multiple, connected computers. Additionally, a multitude of remote hardware components may be incorporated into the system. These remote hardware components compose the Secure Message Center 204.

For security purposes, clearinghouse 200 executes four software components, three inbound and two outbound data feeds. More particularly, clearinghouse component 200 processes the following data feeds.

There is an inbound ANSI feed 301 to clearinghouse 200 of a claim transaction in accordance with specification version 5010/837i mandated by HIPAA or transaction standards amended by OESS; inbound non-ANSI data feed 302, in particular keyed data; inbound non-ANSI data feed 303, in particular, a feed composed of a UB-04 claim in a form and format specified by OMB and the NUBC to be compliant with HIPAA.

The outbound components generated by clearinghouse component 200 are: an outbound ANSI feed 401 composed of files 9999 and 277CA which are HIPAA-approved communications concerning the status of incoming claim file claim feeds 301, 302 and 303. Outbound component 501 comprises database-to-database document transfer software containing claim data and status updates. Outbound component 501 is in communication with hardware component 202.

MedicaFund hardware component 202 executes four types of software components. These are reporting software 502; processing software 503; communications software 504 between MedicaFund 202 and Secure Message Center 204; and communications software 505 between MedicaFund 202 and medical bill generator 100 and bill-payer 102.

Report-generating software 502 includes four major software components. These are Incomplete Report software 600, Tickler Report software 602, Claims in Processing Report software 604, and Aged Trial Balance Report software 606.

Processing software 503 is internal processing software which compares claim information against a checklist, and reviews attached documents. Processing software 503 includes five software subcomponents: checklist inspection software 700; support document examination software 702; claim acceptance evaluator software 704; status updating software 706; and software to determine payable claim amount 708.

Subcomponent 702 reviews a checklist of elements necessary to gain approval from payer 102 for the full payment of a claim. Subcomponent 702 also reviews form UB-04 for insurance-claim compliance. Subcomponent 702 connected with documents supporting said claim which are sent to and received from an MMC application. An MMC application provides planning, management, cost containment, design and other services to physicians and other healthcare providers. MMC applications are customized to the specific needs of medical services providers 100 and payers 102.

Subcomponent 708 approves a payable dollar amount. Said amount is normally discounted for advance payment to provider 100 in anticipation of a predicted full payment from payer 102.

Communications software 504 is internal processing software managing the interactions between MedicaFund 202 and the Secure Message Center 204. Secure Message Center 204 includes a communication software subcomponent 900 to provider 100 notifying whether a claim was or was not accepted, and to give remote accessors 104 access to MedicaFund website and database.

Communications software 505 is internal processing software having three major software subcomponents. These subcomponents are payment software 800 which pays provider 100 by check or electronic transfer; bill-generating software 802 to payer 102; and electronic-payment transfer software 803 from payer 102.

The interactions between the components include:
A. Inbound ANSI 5010/837i feed 301 to electronic clearinghouse 200;
B. Inbound non-ANSI keyed data feed 302 to electronic clearinghouse 200;
C. Inbound non-ANSI UB-04 claim 303 to electronic clearinghouse 200;
D. Electronic clearinghouse 200 to outbound ANSI-compliant 9999 and 277CA file feed 401;
E. Secure Message Center 204 to remote accessors 104, and 104 to 204 (bidirectional);
F. Communications software 504 to MedicaFund component 202;
G. Communications software 504 to Secure Message Center 204;
H. MedicaFund component 202 to report-generating software 502;
I. Outbound component 501 to MedicaFund component 202;
J. Secure Message Center 204 to provider/bill-generator 100;
K. Communications subcomponent 900 to provider/bill-generator 100; and
L. Communications subcomponent 900 to remote accessory 104, and 104 to 900 (bidirectional).
   The foregoing list sets forth major interactions but does not exclude other interactions nor does it suggest sequence or priority.

Additionally, data transmission is performed in a secured and encrypted manner, specifically employing Advanced Encryption Standard (AES) 256-bit protocol or other encryption method required by HIPAA or other controlling authority.

In the preferred embodiment, medical provider 100 generates ANSI 5010/837i data feed 301 which is throughput in an encrypted manner to electronic clearinghouse 200. Subsequently, provider 100 generates non-ANSI keyed feed 302 and UB-04 claim feed 303 to electronic clearinghouse 200.

Clearinghouse 200 generates encrypted outbound ANSI data feed 401 to provider 100. Simultaneously clearinghouse 200 transmits claim data and status updates to Database-to-database transfer software 501 transmits claim data and status updates to MedicaFund component 202 using database-to-database software 501. Upon receipt of the data from 501, MedicaFund 202 initiates two software routines.

The first routine is report software 502 which includes the four subroutines Incomplete Report 600, Tickler Report 602, Claims in Processing Report 604, and Aged Trial Balance Report 606.

The second routine initiated is processing software 503 that is an iterative process involving checklist inspection 700, support document examination 702, claim acceptance evaluation 704, status updating 706 and determination of a payable claim amount 708.

The result of said iterative process will be both an update of reporting software 502 and activation of communication software component 505. Communications software 505 uses elements of payment software 800, bill-generating software 802, and electronic-payment transfer software 803 to send either an electronic or paper payment to medical provider 100, to bill payer 102, and to receive a payment from payer 102.

In an optional embodiment, MedicaFund 202 will also activate communications software 504 to enable participation by remote accessors 104 using Secure Message Center 204 running software subcomponent 900 for communications between provider 100 and remote accessors 104.

The second major component of the current invention is the user-facing system. Said user-facing system is capable of receiving data from said data system; detecting patients and users which are proximate to a common medical service provider; and automatically sending data from said data system concerning said patients to said users.

Said user facing system is composed of three elements which are called as following:

1. Web service—The web service simply “delivers” the dashboard information in a safe, secure, encrypted manner using the internet. The data is pushed out from a set of connected computers through a web service to the monitoring Receiving device.

2. Receiving device—The receiving device is a small device that utilizes a secure wireless connection to the internet and the device is programmed for the specific submitter. The software that resides on the device. The input to the device will be receiving the data sent from the Web Service. The processing on the device will be to format the data in a human readable dashboard format and output will be sending the dashboard to the display panel through the HDMI interface.

3. Display panel—The display panel is simply a display device that accepts an HDMI input and will display the dashboard information received from the receiving device.

The present invention will be providing to the submitter the Web Service configuration and the Receiving Device. Due to the many options on the display panel (Flat Screen TV, monitor, Reader Panel, etc.) and the environmental factors, the present invention is not limited a particular display panel or the cabling that runs from the receiving device to the display panel.

Said user facing system receives its data from said data system using a web Service. Said web service maintains a connection to said users and pulls from said data system.

Said receiving devices processes the data it receives from said web service and formats the data into a human readable dashboard view.

Said receiving device outputs the dashboard through a standard for connecting high-definition video device, such as a HDMI port of the device to said display panel of the user's choosing.

Said user facing system is written in an integrated development environment such as Microsoft Visual Studio using The head element contains, which use server control (rather than static control system such as hypertext markup language, which is the standard system for tagging text files to achieve font, color, graphic, and hyperlink effects on World Wide Web pages) such as ASP.NET and C#.NET as the code base. The back-end database is required such as Microsoft SQL Server.

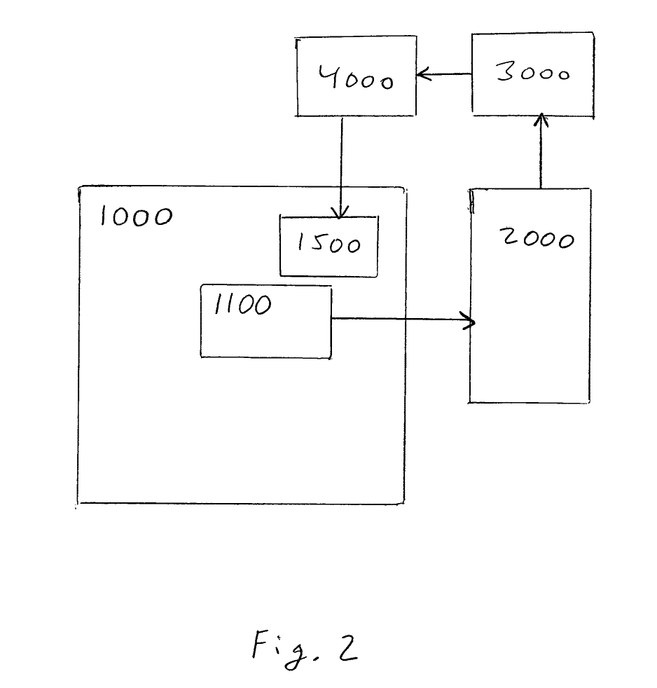

Now referring to FIG. 2 for illustration, when a patient enters a healthcare provider facility 1000, said patient's identifying information is entered into provider-computer 1100. Said patient's healthcare service requirements are entered into provider-computer 1100. Then computer 1100 sends said patient identity and requirements to said data system 2000.

Said data system 2000 processes patient information as described above, including contact with said patient's payer to confirm coverage and amount of said coverage for said patient and patient's healthcare service requirements on a prospective basis. Said data system 2000 communicates said findings concerning said patient to web-service 3000 said patient's reimbursable care service options.

Web-service 3000 communicates with receiving device 4000. Receiving device 4000 communicates to display panel 1500 said patient's reimbursable care service options. In an optional embodiment, receiving device 4000 may be proximal to provider-compute 1100, or elsewhere in facility 1000.

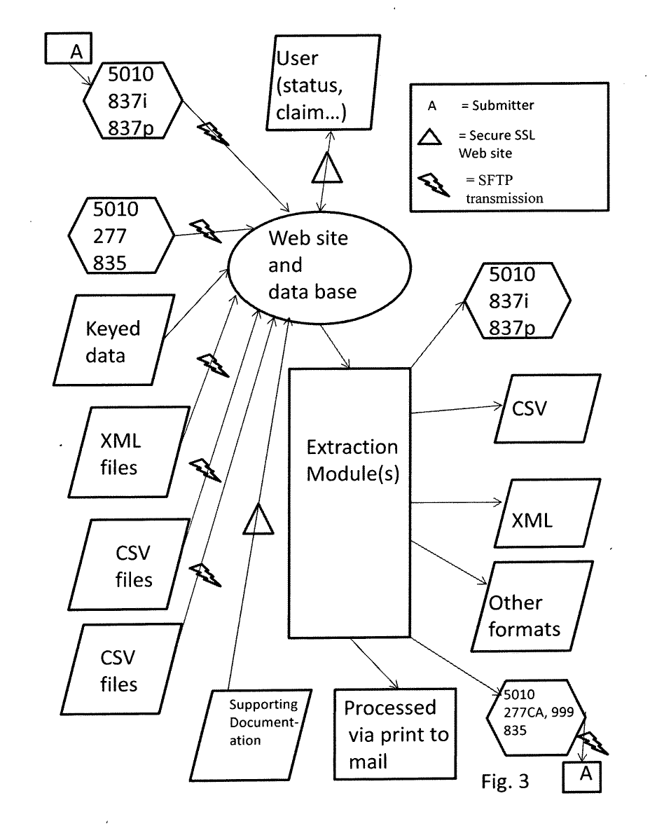

Referring now to FIG. 3, a flowchart schematic is shown of the key inputs and transformations of the worker's compensation element of the present invention (as previously presented in FIG. 1 of 1 of prior provisional application Ser. No. 62/494,845). FIG. 3 demonstrates how said data system may be supplemented by optional components to address particular worker's compensation.

The workers' compensation component of the present invention teaches an apparatus for managing the pre-payment of medical and other healthcare bills using an intermediary, as follows.

The healthcare provider performs a medical or other covered service.

The provider creates an invoice in its own medical billing system or application

The provider either mails or transmits the invoice to its clearinghouse such as the computer system of the current invention.

If supporting documents for the invoice are not included, the provider adds them using the computer system disclosed; then
(a) The computer system application automatically validates the invoice for completeness;
(b) Supporting documents are validated; and
(c) If required, supporting documents are scanned and stored in Managed Claims.

Managed Claims authorizes and releases pre-funding of the invoice (i.e., pre-payment of the unpaid bill) to the healthcare provider.

The pre-funded invoice is transmitted or mailed to the insurer or other payer.

The payer pays the bill and transmits or sends an Explanation of Benefits (EOB) to the computer system of the current invention.

If the invoice was denied or only partial payment was made, reconciliation recourse is applied against the next bill submitted by the healthcare provider.

More particularly, FIG. 3 discloses an apparatus comprising: a computer system associated with a medical provider comprising at least one patient, at least one medical provider, at least one insurance provider and at least one Internet clearinghouse site, as follows:
(a) wherein, the patient receives medical services from the medical provider,
(b) wherein, said medical services are memorialized in at least one bill,
(c) wherein, the insurance provider is willing to pay said bill,
(d) wherein, said willingness is dependent upon the receipt of the insurance provider of documentation of said bill,
(e) wherein, the computer system is operative to transmit data provided by the medical provider bill said clearinghouse and personal information related to the patient,
(d) wherein, the computer system is operative responsive at least in part to receiving said data, to obtain additional information corresponding to said bill and said patient information by transmitting data to said provider, to external users and said managed claims Internet site,
(e) wherein, the computer system is operative responsive at least in part to receiving said data, to determine that the insurance provider may pay an amount equal to the amount set forth in said bill to the advance payer, and
(f) wherein, the computer system is operative to cause a payment to the medical provider in an amount less than said payment to said payment to the advance payer in satisfaction for said bill.

In an alternate embodiment, the apparatus of FIG. 3 is a computer system comprising a wireless mobile device, as follows:
(a) wherein, the computer system is operative to receive said data through the wireless mobile device, and
(b) wherein, the computer system is operative to cause a payment to the medical provider in an amount less than said payment to said payment to the advance payer in satisfaction for said bill through the wireless mobile device.

Still further, the apparatus disclosed in FIG. 3 may include data using AES 256-bit encryption.

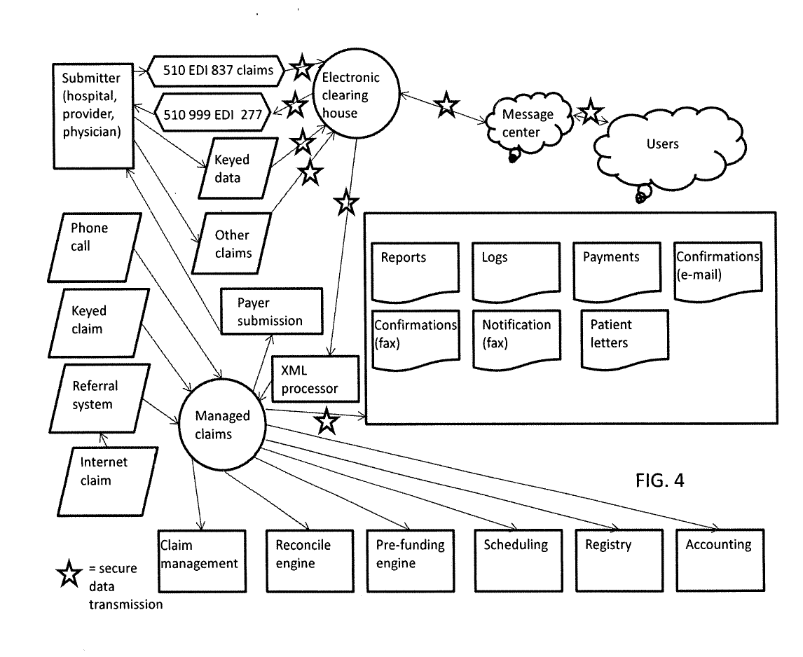

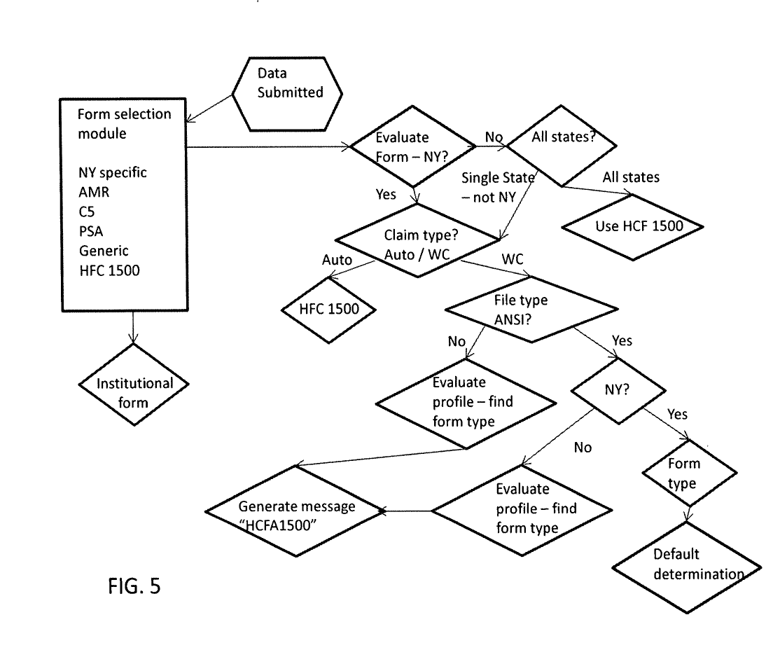

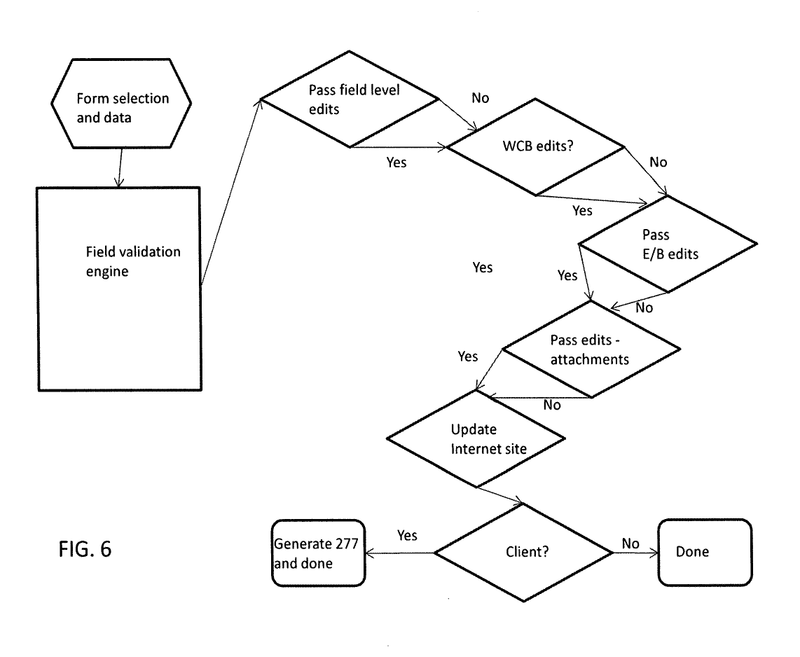

Optional additional payment processing occurs as depicted in FIG. 4, a flowchart detailing the key elements and processes of the current invention; FIG. 5, the protocols necessary to enable the current invention; and FIG. 6, a flowchart depicting the validation and error-summary processes (FIGS. 4-6 were previously presented as FIGS. 1, 2 and 3, respectively, in provisional application Ser. No. 62/494,851).

Referring now to the processes depicted in FIGS. 4-6, the present disclosure teaches an optional process to manage a clearinghouse for automated processing of medical and healthcare-related invoices, supporting medical documents, and payment requests, as follows.

A healthcare provider performs a medical service reimbursable by an insurer or other payer.

The provider creates invoices in its billing system using a standard format such as ANSI 5010 to create an 837P (professional) or 837I (institutional) record.

The provider transmits the invoices to the computer system of the present invention, preferably over the Internet using Secure File Transfer Protocol (SFTP).

The provider uses the computer system of the current invention to transmit supporting documents for the related invoice.

The computer system transmits an acknowledgment of the batch transmission, typically with an ANSI 999 response back to the provider.

The computer system validates that the invoice is complete and not missing required elements or fields.

The computer system validates that the bill has a supporting medical document.

The computer system notifies the provider that the invoice has been validation and or missing components.

The computer system transmits the bill and supporting documents to an insurer or other responsible payer.

The payer transmits a claim acknowledgment, preferably an ANSI 277 CA claim-acknowledgement response to the computer system, indicating its acceptance or rejection of the invoice and supporting documents.

The computer system converts the claim acknowledgment response into human readable terminology and transmits the converted claim acknowledgement back to the healthcare provider that provided the original invoice.

This optional process uses an apparatus as disclosed in FIGS. 4-6, having a computer system associated with a medical provider system comprising at least one patient, at least one medical provider, at least one insurance provider and at least one user, as follows:
(a) wherein, the patient receives medical services from the medical provider,
(b) wherein, said medical services are memorialized in at least one bill,
(c) wherein, the insurance provider is willing to pay said bill,
(d) wherein, said willingness is dependent upon the receipt of the insurance provider of documentation of said bill,
(e) wherein, the computer system is operative to receive data provided by the medical provider system remotely located from said computer system, where said data correspond to said medical provider's services and includes personal information related to the patient,
(f) wherein, the computer system is operative responsive at least in part to receiving said data, to obtain additional information corresponding to the patient from the said medical provider system,
(g) wherein, the computer system is operative responsive at least in part to receiving and send data said user, and
(h) wherein, the computer system is operative to cause a bill to said insurance provider in a form sufficiently satisfactory to yield a payment to said user.

In an alternate embodiment, the apparatus of FIGS. 4-6 is a computer system comprising a wireless mobile device, wherein the computer system is operative to receive said data through the wireless mobile device, and the computer system is operative to cause a payment to the medical provider in an amount less than said payment to said payment to the advance payer in satisfaction for said bill through the wireless mobile device.

In a still further option for security, the data may be encrypted using AES 256-bit encryption.

In the foregoing description, for purposes of explanation, specific numbers, materials and configurations are set forth in order to provide a thorough understanding of the present invention. However, it will be apparent to one skilled in the art that these teachings may be practiced without the specific details. In other instances, well known features are omitted or simplified in order not to obscure the present invention. Furthermore, for ease of understanding, certain method steps are delineated as separate steps, however, these separately delineated steps should not be construed as necessarily order dependent in their performance.

Persons skilled in the art will further recognize that the foregoing embodiments are illustrative and not limiting. This disclosure may be practiced with other embodiments and variations can be adapted to particular circumstances and material. Although certain embodiments and examples are necessarily chosen in describing and claiming the above disclosure, these should not inhibit broader or related applications without departing from the spirit of the invention.

I claim:

1. An apparatus comprising at least three computers, at least three sets of software, at least one web-service, at least one receiving device, at least one display panel, wherein
(a) first of said three computers is located at a healthcare-provider bill-generator site,
(b) second of said three computers is located at a MedicaFund site,
(c) third of said three computers is located at a payer site,
(d) said display panel is located at said healthcare-provider bill-generator site,
(e) said first computer is initiated by the input of a patient's identity and said patient's healthcare requirements,
(f) said patient's identity and requirements initiate a first communication to said second computer,
(g) said second computer initiates a second communication to said third computer,
(h) said second communication queries said third computer as to reimbursement,
(i) said third computer calculates said reimbursement,
(j) said third computer initiates a third communication to said second computer with authorization to pay said reimbursement,
(k) said second computer initiates a fourth communication to said web-service,
(l) said web-service initiates a fifth communication to said receiving device,
(m) receiving device initiates a sixth communication to said display panel,
(n) said first computer initiates said seventh communication to said second computer confirming execution of healthcare service to said patient,
(o) said second computer initiates an eighth communication to a funds holder authorizing transfer of payment to said healthcare-provider bill-generator.

2. The apparatus according to claim 1, wherein said display panel can display status of said reimbursement.
